(19) United States
(12) Patent Application Publication
(10) Pub. No.: US 2026/0237791 A1
(43) Pub. Date: Aug. 13, 2026

(54) LIQUID COOLING MODULE AND BATTERY PACK

(71) Applicant: EVE ENERGY CO., LTD., Huizhou (CN)

(72) Inventors: Yuqi HE, Huizhou (CN); Zaigang DU, Huizhou (CN)

(73) Assignee: EVE ENERGY CO., LTD., Huizhou (CN)

(21) Appl. No.: 19/638,228

(22) Filed: Apr. 3, 2026

Related U.S. Application Data
(63) Continuation of application No. PCT/CN2025/090045, filed on Apr. 21, 2025.

(30) Foreign Application Priority Data
Nov. 19, 2024 (CN) 202411658167.7
Nov. 19, 2024 (CN) 202422824737.7

(51) Int. Cl. H01M 10/6568; H01M 10/613; H01M 10/6556; H01M 50/204; B60L 50/64; B60L 58/26

(52) U.S. Cl. CPC H01M 10/6568; H01M 10/613; H01M 10/6556; H01M 50/204; B60L 50/64; B60L 58/26

(57) ABSTRACT

A liquid cooling module and a battery pack are provided. The liquid cooling module includes a first liquid cooling plate which further comprises a flow channel and a second liquid cooling plate spaced apart from the first liquid cooling plate. A first cooling portion is disposed in the second liquid cooling plate and is in fluid communication with the flow channel of the first liquid cooling plate to guide cooling liquid into or out of the first cooling portion. The battery pack includes a battery module positioned between the first liquid cooling plate and the second liquid cooling plate.

### CROSS-REFERENCE TO RELATED APPLICATIONS

This application is a U.S. bypass continuation of International Patent Application PCT/CN2025/090045, filed on Apr. 21, 2025, which claims priority to Chinese Application Nos. 202411658167.7 and 202422824737.7, both filed on Nov. 19, 2024. The entire contents of each of the above-referenced applications are expressly incorporated herein by reference.

### TECHNICAL FIELD

The present disclosure relates to the field of battery technology, particularly to a liquid cooling module and a battery pack.

### BACKGROUND

As an energy storage and power output device for electric vehicles, a power battery pack is a power source for electric vehicles. To ensure the normal operation of the power battery pack, the battery module in the power battery pack needs to be equipped with a corresponding heat dissipation structure, such as a liquid cooling system, to dissipate the heat generated during the operation of the battery module as quickly as possible. In current practice, the input and output of cooling liquid to and from liquid cooling plates in the liquid cooling system are achieved through pipelines. As the number of stacking layers of the battery pack increases, the parallel connection of liquid cooling plates in the pipeline design makes it difficult to overcome space constraints, thus limiting the mounting of the liquid cooling plates.

### SUMMARY

In view of the complex spatial layout faced by the pipeline design for the liquid cooling system in related technologies, it is necessary to further optimize the liquid cooling module to meet the needs of large-capacity battery packs.

In a first aspect, embodiments of the present disclosure provide a liquid cooling module, including: a first liquid cooling plate, in which a flow channel is arranged; and a second liquid cooling plate, spaced apart from the first liquid cooling plate, in which a first cooling portion is arranged in the second liquid cooling plate, and the first cooling portion is in communication with the flow channel to guide cooling liquid into the first cooling portion or to guide the cooling liquid out of the first cooling portion.

In a second aspect, embodiments of the present disclosure provide a battery pack, including a battery module and a liquid cooling module. The liquid cooling plate includes: a first liquid cooling plate, in which a flow channel is arranged; and a second liquid cooling plate, spaced apart from the first liquid cooling plate, in which a first cooling portion is arranged in the second liquid cooling plate, and the first cooling portion is in communication with the flow channel to guide cooling liquid into the first cooling portion or to guide the cooling liquid out of the first cooling portion. The battery module is arranged between adjacent liquid cooling plates.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic diagram of an exemplary structure of a battery pack provided in an embodiment of the present disclosure.

FIG. 2 is a schematic diagram of an exemplary structure of a liquid cooling module provided in an embodiment of the present disclosure.

FIG. 3 is a top view of an exemplary liquid cooling module provided in an embodiment of the present disclosure.

FIG. 4 is a schematic top view of an exemplary first liquid cooling plate provided in an embodiment of the present disclosure.

FIG. 5 is schematic a top view of an exemplary second liquid cooling plate provided in an embodiment of the present disclosure.

FIG. 6 is a schematic diagram of an exemplary structure of a first joint provided in an embodiment of the present disclosure.

FIG. 7 is a schematic diagram of another exemplary structure of the first joint provided in an embodiment of the present disclosure.

FIG. 8 is a schematic diagram of an exemplary structure of a first connecting joint provided in an embodiment of the present disclosure.

FIG. 9 is a schematic diagram of an exemplary structure of a third liquid cooling plate provided in an embodiment of the present disclosure.

### DETAILED DESCRIPTION

In the description of the present disclosure, unless otherwise clearly specified and limited, the terms “connected to”, “connected”, and “fixed” should be understood in a broad sense, for example, it can be a fixed connection, a detachable connection, or an integral connection; it can be a mechanical connection or an electrical connection; it can be a direct connection or an indirect connection through an intermediate medium; and it can be an internal connection of two elements or an interaction relationship between two elements. For a person of ordinary skill in the art, the specific meanings of the above terms in the present disclosure can be understood according to the specific circumstances.

In the present disclosure, unless otherwise clearly specified and limited, a first feature being “on” or “under” a second feature may include the first and second features being in direct contact, or may include the first and second features being in contact not directly but through another feature between them. Moreover, a first feature being “on”, “up of” and “above” a second feature includes the first feature being directly above and obliquely above the second feature, and the first feature having a higher horizontal height than the second feature. A first feature being “under”, “down of” and “below” a second feature includes the first feature being directly below and obliquely below the second feature, and the first feature having a lower vertical height than the second feature.

In the description of this embodiment, the terms “upper”, “lower”, “left”, “right”, “front”, “rear” and other directions or positional relationships are based on the directions or positional relationships shown in the accompanying drawings, and are for the convenience of description and simplification of operation, rather than indicating or implying that the device or element referred to must have a specific direction, be constructed and operate in a specific direction, and therefore cannot be understood as limiting the present disclosure. In addition, the terms “first” and “second” are used to distinguish in the description and have no special meaning.

Reference will now be made in detail to exemplary embodiments, examples of which are illustrated in the accompanying drawings. The following description refers to the accompanying drawings in which the same numbers in different drawings represent the same or similar elements unless otherwise represented.

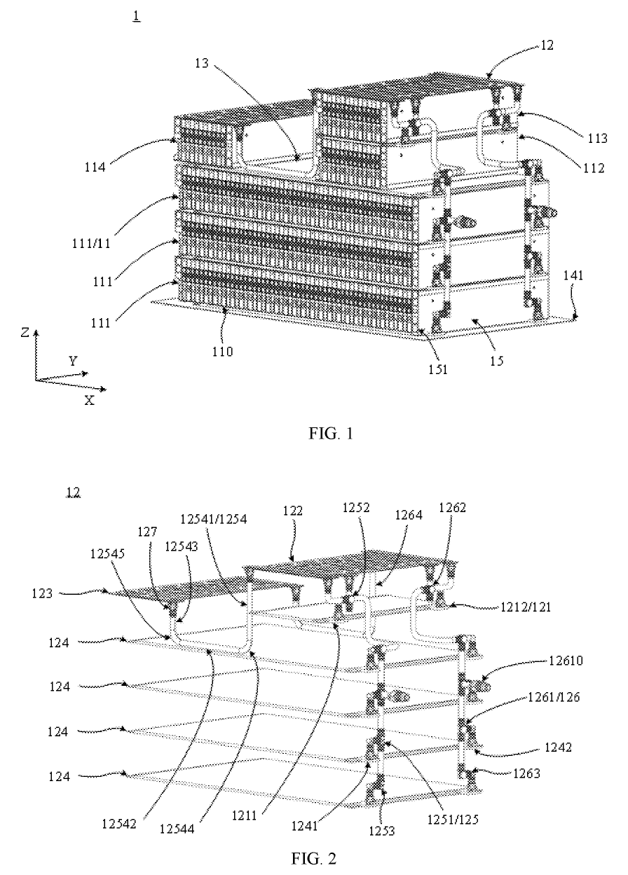

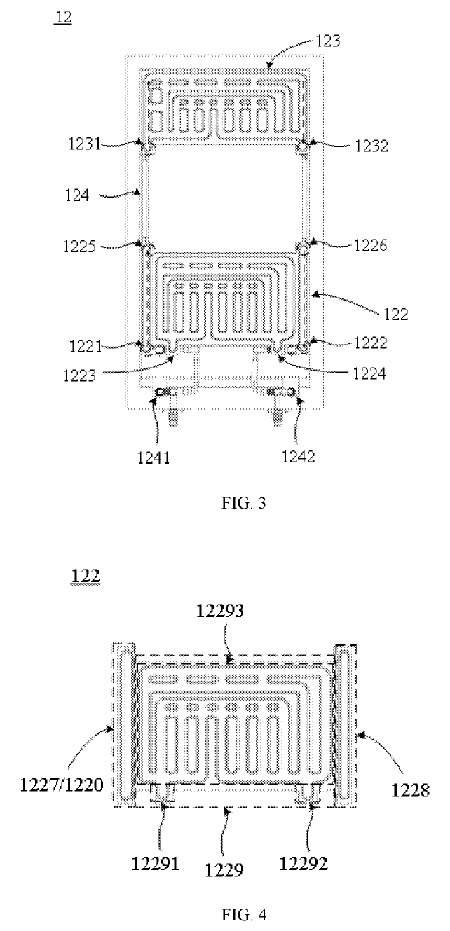

Referring to FIGS. 1-5, FIG. 1 is a schematic diagram of an exemplary structure of a battery pack provided in an embodiment of the present disclosure. FIG. 2 is a schematic diagram of an exemplary structure of a liquid cooling module provided in an embodiment of the present disclosure. FIG. 3 is a top view of an exemplary liquid cooling module provided in an embodiment of the present disclosure. FIG. 4 is a schematic top view of an exemplary first liquid cooling plate provided in an embodiment of the present disclosure. FIG. 5 is a schematic top view of an exemplary second liquid cooling plate provided in an embodiment of the present disclosure.

Referring to FIG. 1, in an embodiment, a battery pack 1 includes a battery module 11 and a liquid cooling module 12. The liquid cooling module 12 includes multiple liquid cooling plates arranged in a stacked manner, and the battery module 11 is arranged between adjacent liquid cooling plates.

Referring to FIG. 2, the liquid cooling module 12 includes a third liquid cooling plate 121, a first liquid cooling plate 122, and a second liquid cooling plate 123. The first liquid cooling plate 122 is arranged above the third liquid cooling plate 121. A flow channel 1220 is arranged in the first liquid cooling plate 122. The second liquid cooling plate 123 is spaced apart from the first liquid cooling plate 122. A first cooling portion 1230 is arranged at the second liquid cooling plate 123. The first cooling portion 1230 is in communication with the flow channel 1220 to guide cooling liquid into the first cooling portion 1230 or to guide the cooling liquid out of the first cooling portion 1230, so that the cooling liquid flows between the first liquid cooling plate 122 and the second liquid cooling plate 123, simplifying the flow path of the cooling liquid, eliminating the need for bent or excessively long pipelines, and thereby increasing the space utilization inside the battery pack 1.

Referring to FIGS. 3 and 4, in an embodiment, a first liquid inlet flow channel 1227 and a first liquid outlet flow channel 1228 are arranged in the flow channel 1220. A second cooling portion 1229 located between the first liquid inlet flow channel 1227 and the first liquid outlet flow channel 1228 is further arranged in the first liquid cooling plate 122. The first liquid cooling plate 122 includes a first sub-inlet 1221, a first sub-outlet 1222, a second sub-inlet 1223, and a second sub-outlet 1224.

Referring to FIGS. 3 and 4, an end of the second cooling portion 1229 is connected to the second sub-inlet 1223, and another end of the second cooling portion 1229 is connected to the second sub-outlet 1224. An end of the first liquid inlet flow channel 1227 is connected to the first sub-inlet 1221, and another end of the first liquid inlet flow channel 1227 is connected to an end of the first cooling portion 1230. Referring to FIGS. 3, 4, and 5, an end of the first liquid outlet flow channel 1228 is connected to the first sub-outlet 1222, and another end of the first liquid outlet flow channel 1228 is connected to another end of the first cooling portion 1230.

In some embodiments, the second liquid cooling plate 123 is arranged in the same layer and spaced apart from the third liquid cooling plate 121 along a first direction Z. The second liquid cooling plate 123 includes a second inlet 1231 and a second outlet 1232. An end of the first liquid inlet flow channel 1227 is connected to the first sub-inlet 1221, and another end of the first liquid inlet flow channel 1227 is connected to the second inlet 1231. An end of the first liquid outlet flow channel 1228 is connected to the first sub-outlet 1222, and another end of the first liquid outlet flow channel 1228 is connected to the second outlet 1232. An end of the second cooling portion 1229 is connected to the second sub-inlet 1223, and another end of the second cooling portion 1229 is connected to the second sub-outlet 1224.

The connection between an end of the first liquid inlet flow channel 1227 and the first sub-inlet 1221, and the connection between an end of the first liquid outlet flow channel 1228 and the first sub-outlet 1222 are both achieved through pipelines. In this embodiment, through such an arrangement that an end of the first liquid inlet flow channel 1227 is connected to the first sub-inlet 1221, and another end of the first liquid inlet flow channel 1227 is connected to the second inlet 1231; and an end of the first liquid outlet flow channel 1228 is connected to the first sub-outlet 1222, and another end of the first liquid outlet flow channel 1228 is connected to the second outlet 1232, the cooling liquid is transported from the first liquid cooling plate 122 to the second liquid cooling plate 123. The second liquid inlet flow channel 12291 and the second liquid outlet flow channel 12292 serve as transition pipelines to simplify the flow path of the cooling liquid, so as to eliminate the need for bent or excessively long pipelines in the related technologies, which reduces the space occupied by the pipelines, and increases the space utilization inside the battery pack 1.

Furthermore, the flow rate of the cooling liquid is uniformly distributed between the first liquid cooling plate 122 and the second liquid cooling plate 123, which is critical for effective cooling of a multi-layered structure, avoiding overcooling or overheating of some cooling plates, and ensuring an overall cooling effect of the liquid cooling module 12.

It should be noted that the first direction refers to a direction Z in FIG. 1, that is, a height direction of the battery module 11 in FIG. 1; a second direction refers to a direction X in FIG. 1, that is, a length direction of the battery module 11 in FIG. 1; and a third direction refers to a direction Y in FIG. 1, that is, a width direction of the battery module 11 in FIG. 1.

Referring to FIGS. 3 and 4, in an embodiment, the second cooling portion 1229 includes a second liquid inlet flow channel 12291, a second liquid outlet flow channel 12292, and a plurality of first liquid cooling flow channels 12293 arranged in parallel. An end of the second liquid inlet flow channel 12291 is connected to the second sub-inlet 1223, another end of the second liquid inlet flow channel 12291 is in fluid communication with an end of the plurality of first liquid cooling flow channels 12293, another end of the plurality of first liquid cooling flow channels 12293 is in fluid communication with an end of the second liquid outlet flow channel 12292, and another end of the first liquid outlet flow channel 1228 is connected to the second sub-outlet 1224.

In this embodiment mentioned above, through arrangement of the second liquid inlet flow channel 12291, the second liquid outlet flow channel 12292, and the plurality of first liquid cooling flow channels 12293 arranged in parallel in the first liquid cooling plate 122, the flow path of the cooling liquid in the first liquid cooling plate 122 is optimized. The second liquid inlet flow channel 12291 and the second liquid outlet flow channel 12292 effectively controls the flow rate of the cooling liquid, so that the flow rate is uniform in each of the first liquid cooling flow channels 12293, which alleviates the problems of excessive high fluid resistance or unstable flow rate that may occur in a single channel, thereby achieving effective fluid management.

In some embodiments, once the cooling liquid enters the second liquid inlet flow channel 12291 through the second sub-inlet 1223, the second liquid inlet flow channel 12291 guides the cooling liquid to be uniformly distributed to each of the first liquid cooling flow channels 12293 arranged in parallel, thereby avoiding excessively high or low flow rate in a certain first liquid cooling flow channel 12293, reducing the resistance difference of the cooling liquid in different paths, and ensuring the balance between an outlet flow speed and a flow rate of each flow channel. Moreover, through the second liquid outlet flow channel 12292, the cooling liquid in each of the first liquid inlet flow channels 1227 is uniformly collected and discharged from the second sub-outlet 1224, thereby realizing uniform flow of the cooling liquid in each liquid cooling plate, improving the overall heat dissipation effect and the fluid balance of the system.

Referring to FIGS. 3, 4, and 5, in an embodiment, the first cooling portion 1230 includes a third liquid inlet flow channel 1233, a third liquid outlet flow channel 1234, and a plurality of second liquid cooling flow channels 1235 arranged in parallel. An end of the third liquid inlet flow channel 1233 is connected to the second inlet 1231, another end of the third liquid inlet flow channel 1233 is in fluid communication with an end of the plurality of second liquid cooling flow channels 1235, another end of the plurality of second liquid cooling flow channels 1235 is in fluid communication with an end of the third liquid outlet flow channel 1234, and another end of the third liquid outlet flow channel 1234 is connected to the second outlet 1232.

In this embodiment, through such an arrangement that the first cooling portion 1230 includes the second liquid inlet flow channel 12291, the second liquid outlet flow channel 12292, and the plurality of second liquid cooling flow channels 1235 arranged in parallel, the flow path of the cooling liquid in the second liquid cooling plate 123 is optimized. The second liquid inlet flow channel 12291 and the second liquid outlet flow channel 12292 effectively controls the flow rate of the cooling liquid, so that the flow rate is uniform in each of the second liquid cooling flow channels 1235, which alleviates the problems of excessive high fluid resistance or unstable flow rate that may occur in a single channel, thereby achieving effective fluid management.

Referring to FIGS. 4 and 5, the first liquid inlet flow channel 1227 is not in fluid communication with the second liquid inlet flow channel 12291, or the first liquid outlet flow channel 1228 is not in fluid communication with the second liquid outlet flow channel 12292.

It should be noted that in this embodiment, the connection methods among the first liquid inlet flow channel 1227, the second liquid inlet flow channel 12291, the first liquid outlet flow channel 1228, and the second liquid outlet flow channel 12292 are not specifically limited thereto. However, in order to illustrate the innovation of the present disclosure, in this embodiment, the case where the first liquid inlet flow channel 1227 is not in fluid communication with the second liquid inlet flow channel 12291, and the first liquid outlet flow channel 1228 is not in fluid communication with the second liquid outlet flow channel 12292 is taken as an example to illustrate the technical solution of the present disclosure.

In this embodiment, a separate loop is formed by the first liquid inlet flow channel 1227, the third liquid inlet flow channel 1233, the second liquid cooling flow channels 1235, the third liquid outlet flow channel 1234, and the first liquid outlet flow channel 1228, and another separate loop is formed by the second liquid inlet flow channel 12291, the first liquid cooling flow channel 12293, and the first liquid outlet flow channel 1228, thereby avoiding intersection and interference between different liquid flows and ensuring that the cooling liquid flow in each loop is independently controlled.

Referring to FIGS. 3 and 4, in some embodiments, an end of the first liquid inlet flow channel 1227 is connected to the first sub-inlet 1221, and an end of the second liquid inlet flow channel 12291 is connected to the second sub-inlet 1223, thereby ensuring that the cooling liquid flows in different flow channels individually, avoiding the mixing of the cooling liquid in flow channels, and making the operation of the liquid cooling module stable. Moreover, the first liquid inlet flow channel 1227 is not in fluid communication with the second liquid inlet flow channel 12291, and the first liquid outlet flow channel 1228 is not in fluid communication with the second liquid outlet flow channel 12292, which avoids excessive high fluid resistance or pressure drop in the first liquid cooling plate 122, and ensures that the flow speed and pressure of the cooling liquid in each flow channel of the first liquid cooling plate 122 remain uniform.

Referring to FIGS. 4 and 5, in an embodiment, the first liquid inlet flow channel 1227, the first liquid outlet flow channel 1228, the third liquid inlet flow channel 1233, and the third liquid outlet flow channel 1234 are all of linear flow channel structures.

The linear flow channel structures reduce the friction and resistance of the cooling liquid in the flow channels, so as to ensure that the cooling liquid passes through each flow channel smoothly, and allow the cooling liquid flow quickly with low energy consumption, thereby improving the flow efficiency of the overall system. In addition, the design of the linear flow channel simplifies the manufacturing process and reduces the processing difficulty and cost caused by a complex flow channel design.

Referring to FIGS. 2 and 3, in an embodiment, the third liquid cooling plate 121 includes a first inlet 1211 and a first outlet 1212 that are in fluid communication with each other. The liquid cooling module 12 includes a plurality of fourth liquid cooling plates 124, first joint pipeline assembly 125, and second joint pipeline assembly 126. The fourth liquid cooling plates 124 are arranged on a side of the third liquid cooling plate 121, away from the third liquid cooling plate 121. The plurality of fourth liquid cooling plates 124 are spaced apart along the first direction Z, and each of the fourth liquid cooling plates 124 includes a third inlet 1241 and a third outlet 1242. The third liquid cooling plate 121 is spaced apart from the fourth liquid cooling plates 124, and the area of the third liquid cooling plate 121 is smaller than the area of the fourth liquid cooling plate 124.

The first joint pipeline assembly 125 is arranged at the ends of the plurality of fourth liquid cooling plates 124. The second joint pipeline assembly 126 is arranged at another end of the plurality of fourth liquid cooling plates 124. The first inlet 1211, the first sub-inlet 1221, the second sub-inlet 1223, and the third inlet 1241 are connected through the first joint pipeline assembly 125; and the first outlet 1212, the first sub-outlet 1222, the second sub-outlet 1224, and the third outlet 1242 are connected through the second joint pipeline assembly 126. The first joint pipeline assembly 125 and the second joint pipeline assembly 126 are spaced apart from each other along the second direction X, and the second direction X is arranged at a right angle relative to the first direction Z.

Referring to FIG. 1, the battery module 11 includes a plurality of battery cells 110. The battery cells 110 are square battery cells 110. The plurality of battery cells 110 are arranged in sequence along the third direction Y. The third direction Y is arranged at a right angle relative to the first direction Z.

Along the second direction X, end plates 15 are provided at two ends of the battery module 11, a plurality of vents 151 are formed in the end plates 15, and the vents 151 penetrate through the end plates 15 along the third direction Y. Vents 151 allow air or cooling gas to flow freely along the third direction Y, thereby effectively dissipating heat from the battery module 11, so as to keep an operating temperature of the battery module 11 within a safe range during high power output or long-term operation, thereby avoiding performance degradation or thermal runaway due to overheating.

Referring to FIGS. 1, 2, and 3, in some embodiments, the battery pack 1 includes a plurality of first battery modules 111 and a second battery module 112. The plurality of first battery modules 111 are spaced apart along the first direction Z. Each of the first battery modules 111 is arranged between two adjacent fourth liquid cooling plates 124. The second battery modules 112 are arranged above the first battery modules 111. The second battery modules 112 are arranged between the fourth liquid cooling plates 124 and the third liquid cooling plate 121. Two adjacent fourth liquid cooling plates 124 are respectively located at the top and the bottom of the first battery modules 111 to achieve double-sided cooling of the first battery modules 111. One of the fourth liquid cooling plates 124 and the third liquid cooling plate 121 are respectively located at a top and a bottom of the second battery module 112 to achieve double-sided cooling of the second battery module 112. As such, the cooling liquid effectively covers the entire surface of the first battery modules 111 and the second battery modules 112, thereby improving the uniformity and efficiency of heat dissipation, preventing local overheating of the battery pack 1, and improving the overall thermal management capability.

It should be noted that the first joint pipeline assembly 125 is arranged at an end of the plurality of fourth liquid cooling plates 124, which means that the first joint pipeline assembly 125 is arranged at an end of the fourth liquid cooling plates 124 close to the third inlet 1241. The second joint pipeline assembly 126 is arranged at another end of the plurality of fourth liquid cooling plates 124, which means that the second joint pipeline assembly 126 is arranged at an end of the fourth liquid cooling plates 124 close to the third outlet 1242.

It can be understood that in this embodiment, the plurality of fourth liquid cooling plates 124 are spaced apart along the first direction Z, the third liquid cooling plate 121 is arranged above the fourth liquid cooling plates 124, and the third liquid cooling plate 121 is spaced apart from the fourth liquid cooling plates 124, so that a layered cooling is achieved, that is, the heat from the battery modules 11 located at different heights in the battery pack 1 is effectively dissipated simultaneously. Moreover, the first inlet 1211, the first sub-inlet 1221, the second sub-inlet 1223, and the third inlet 1241 are connected together through the first joint pipeline assembly 125, and the first outlet 1212, the first sub-outlet 1222, the second sub-outlet 1224, and the third outlet 1242 are connected together through the second joint pipeline assembly 126, so that the plurality of fourth liquid cooling plates 124, one third liquid cooling plate 121, one first liquid cooling plate 122 and one second liquid cooling plate 123 are connected in parallel, thereby improving the flow uniformity of the cooling liquid and temperature control capability.

In addition, in this embodiment, the area of the third liquid cooling plate 121 is configured to be smaller than the area of the fourth liquid cooling plates 124, so that the space inside the battery pack 1 is effectively saved, which is applicable for arrangement in the multi-layered battery pack 1, especially in a case that height is limited in the first direction Z. The fourth liquid cooling plates 124 with a large area are configured to cool the main area of the battery pack 1, and the third liquid cooling plate 121 with a small area are configured to cool an upper area of the battery pack 1. This arrangement provides a flexible temperature control solution, which helps to achieve uniform temperature distribution and reduce the risk of local overheating.

In addition, the plurality of fourth liquid cooling plates 124, the third liquid cooling plates 121, and the first liquid cooling plates 122 are spaced apart along the first direction Z, so that a close stacking of the cooling plates is avoided, making the pipeline arrangement flexible, effectively utilizing the available space in the battery pack 1, eliminating complex pipeline connections and reducing layout difficulty.

Furthermore, the first inlet 1211, the first sub-inlet 1221, the second sub-inlet 1223, and the third inlet 1241 are connected together through the first joint pipeline assembly 125, and the first outlet 1212, the first sub-outlet 1222, the second sub-outlet 1224, and the third outlet 1242 are connected together through the second joint pipeline assembly 126, so that a layered cooling structure arranged in parallel is formed through the plurality of fourth liquid cooling plates 124, the third liquid cooling plate 121, and the first liquid cooling plate 122, and thus the liquid cooling module 12 is applicable for a complex layered structure of the multi-layered battery module 11. In addition, a parallel design not only improves the cooling efficiency of the liquid cooling module 12, but also reduces the impact caused by the performance difference of the single layer of liquid cooling plate, ensuring that the cooling liquid flows smoothly through a plurality of layers of liquid cooling plates, thereby ensuring that the temperature of the entire battery pack 1 is the same.

Referring to FIGS. 1, 2, and 4, in an embodiment, the plurality of fourth liquid cooling plates 124, the third liquid cooling plate 121, and the first liquid cooling plate 122 are spaced apart along the first direction Z. An area of the first liquid cooling plate 122 is equal to the area of the third liquid cooling plate 121. The battery pack 1 includes a third battery module 113, and the third battery module 113 is arranged between the third liquid cooling plate 121 and the first liquid cooling plate 122.

In this embodiment, the third liquid cooling plate 121 and the first liquid cooling plate 122 are respectively arranged at a top and a bottom of the third battery module 113, so as to achieve double-sided cooling of the third battery module 113, so that the cooling liquid effectively covers the entire surface of the third battery module 113, thereby improving the uniformity and efficiency of heat dissipation, preventing local overheating of the battery pack 1, and improving the overall thermal management capability.

In some embodiments, battery pack 1 includes a third battery module 113, and the third battery module 113 is arranged between the third liquid cooling plate 121 and the first liquid cooling plate 122. The third liquid cooling plate 121 and the first liquid cooling plate 122 are respectively arranged at the top and the bottom of the third battery module 113. These two cooling plates can achieve double-sided cooling of the third battery module 113, so that the cooling liquid effectively covers the entire surface of the third battery module 113. This can lead to improvements such as the uniformity and efficiency of heat dissipation, preventing local overheating of the battery pack 1, thus improving the overall thermal management capability.

In addition, the plurality of first liquid cooling flow channels 12293 arranged in parallel allow the cooling liquid pass through the liquid cooling plates quickly, thereby increasing a cooling surface area of the first liquid cooling plate 122 in contact with the third battery module 113, thereby effectively improving the cooling efficiency. In addition, since the plurality of first liquid cooling flow channels 12293 are arranged in parallel, the cooling liquid is uniformly distributed in each of the first liquid cooling flow channels 12293, thereby avoiding local overheating or uneven cooling of the third battery module 113.

Referring to FIGS. 1, 2, 4, and 5, in an embodiment, the second liquid cooling plate 123 is arranged above the third liquid cooling plate 121, and the second liquid cooling plate 123 is spaced apart from the fourth liquid cooling plates 124. The area of the second liquid cooling plate 123 is equal to the area of the third liquid cooling plate 121. The battery pack 1 includes a fourth battery module 114, and the fourth battery module 114 is arranged between the fourth liquid cooling plates 124 and the second liquid cooling plate 123. The second liquid cooling plate 123 and the fourth liquid cooling plates 124 are respectively arranged at the top and the bottom of the fourth battery module 114 to achieve double-sided cooling of the fourth battery module 114. Accordingly, the cooling liquid effectively covers the entire surface of the fourth battery module 114, which improves the uniformity and efficiency of heat dissipation, prevents local overheating of the battery pack 1, and improves the overall thermal management capability.

In addition, the plurality of second liquid cooling flow channels 1235 arranged in parallel allow the cooling liquid pass through the liquid cooling plate quickly, thereby increasing the cooling surface area of the second liquid cooling plate 123 in contact with the fourth battery module 114, thereby effectively improving the cooling efficiency. In addition, since the plurality of second liquid cooling flow channels 1235 are arranged in parallel, the cooling liquid is uniformly distributed in each of the first liquid cooling flow channels 12293, thereby avoiding local overheating or uneven cooling of the fourth battery module 114.

Referring to FIGS. 1-5, in an embodiment, the third inlet 1241 and the third outlet 1242 are located at the same end of the fourth liquid cooling plates 124. The first inlet 1211 and the first outlet 1212 are located at a same end of the third liquid cooling plate 121. The first sub-inlet 1221, the first sub-outlet 1222, the second sub-inlet 1223, and the second sub-outlet 1224 are located at the same end of the first liquid cooling plate 122. The second inlet 1231 and the second outlet 1232 are located at the same end of the second liquid cooling plate 123. And the second inlet 1231 and the second outlet 1232 are located at an end of the second liquid cooling plate 123 close to the third liquid cooling plate 121.

In some embodiments, the third inlet 1241, the third outlet 1242, the first inlet 1211, the first outlet 1212, the first sub-inlet 1221, the first sub-outlet 1222, the second sub-inlet 1223, the second sub-outlet 1224, the first joint pipeline assembly 125, and the second joint pipeline assembly 126 are all arranged at a same end of the liquid cooling module 12.

The cooling plates in the multi-layered battery pack 1 require different routings of the pipelines due to differences in height and spacing. In a case that inlets and outlets and pipeline assemblies are distributed at different ends, it would lead to complex intersection and routing problems of the pipelines. In this embodiment, all the inlets and outlets and pipeline assemblies are arranged at the same end of the liquid cooling module 12, so that the pipelines do not need to extend or be arranged from multiple directions during mounting. An arrangement of the pipelines is simply adjusted based on the position of each layer of cooling plates to adapt to different numbers of layers and cooling requirements. This arrangement improves the compatibility of liquid cooling module 12 and reduces the space occupied by the pipelines in liquid cooling module 12, thereby achieving flexible layout of the pipelines in the structure of the multi-layered battery pack 1. Therefore, it solves the pipeline layout problem in a case that the space in the battery pack 1 is limited and meets the heat dissipation needs of a large-capacity battery pack 1.

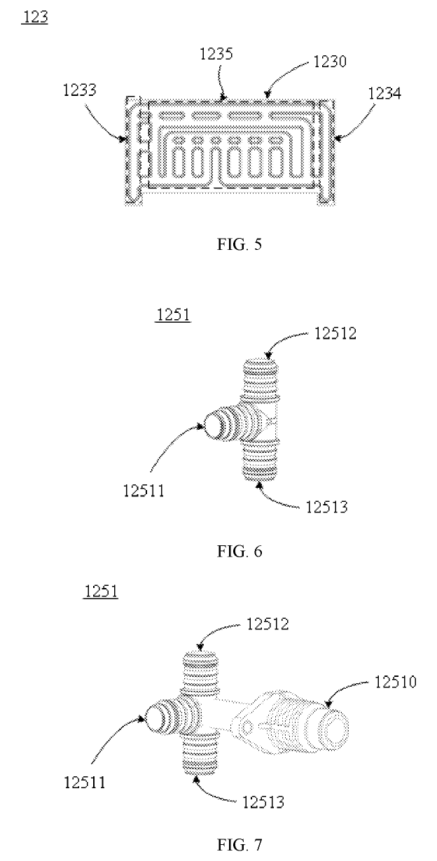

Referring to FIGS. 1-6, FIG. 6 is a schematic diagram of an exemplary structure of a first joint provided in an embodiment of the present disclosure.

In an embodiment, the first joint pipeline assembly 125 includes a plurality of first joints 1251 in fluid communication with each other, one of the first joints 1251 is in fluid communication with the third inlet 1241 of one of the fourth liquid cooling plates 124, and one of the plurality of first joints 1251 close to the third liquid cooling plate 121 is in fluid communication with the first inlet 1211. The second joint pipeline assembly 126 includes a plurality of second joints 1261 in fluid communication with each other, one of the second joints 1261 is in fluid communication with the third outlet 1242 of one of the fourth liquid cooling plates 124, and one of the plurality of second joints 1261 close to the third liquid cooling plate 121 is in fluid communication with the first outlet 1212.

It should be noted that adjacent first joints 1251, the first joints 1251 and the third inlet 1241, the first joints 1251 and the first inlet 1211, adjacent second joints 1261, the second joints 1261 and the third outlet 1242, as well as the second joints 1261 and the first outlet 1212 are all connected through pipelines.

In some embodiments, the first joints 1251 are three-way joints, and each of the first joints 1251 includes a first opening 12511, a second opening 12512, and a third opening 12513 in fluid communication with each other. The first opening 12511 of one of the first joints 1251 is in fluid communication with the third inlet 1241 of one of the fourth liquid cooling plates 124. Along the first direction Z, in two adjacent first joints 1251, the second opening 12512 of one of the first joints 1251 is in fluid communication with the second opening 12512 or the third opening 12513 of another one of the first joints 1251, thereby realizing a fluid communication between the plurality of first joints 1251.

The three-way joints in the related technologies are conventionally assembled from a plurality of components, and a sealing performance at a connection is susceptible to mounting accuracy and operating environment, which causes leakage of the cooling liquid. In this embodiment, the first joints 1251 are configured to be three-way joints. Each of the first joints 1251 includes a first opening 12511, a second opening 12512, and a third opening 12513 in fluid communication with each other. Through reduction of the volume of a connecting part and optimization of the design of the flow channels, the extension length and layout of the pipeline in the second direction X in the related technologies are reduced, thereby saving the space inside the battery pack 1.

It should be noted that, in this embodiment, the second direction X is the direction X in FIG. 1, or the second direction X is a length direction of the battery module 11. In addition, the structure of the second joints 1261 is same as the structure of the first joints 1251, that is, the second joints 1261 are also three-way joints. Please refer to the above description of the first joints 1251 for details, which are not repeated in this embodiment.

In this embodiment, one of the first joints 1251 is in fluid communication with the third inlet 1241 of one of the fourth liquid cooling plates 124, and one of the plurality of first joints 1251 close to the third liquid cooling plate 121 is in fluid communication with the first inlet 1211; and one of the second joints 1261 is in fluid communication with the third outlet 1242 of one of the fourth liquid cooling plates 124, and one of the plurality of second joints 1261 close to the third liquid cooling plate 121 is in fluid communication with the first outlet 1212, so that the plurality of fourth liquid cooling plates 124 and one third liquid cooling plate 121 are arranged in parallel, and a flow rate of the cooling liquid in each liquid cooling plate is uniform, thereby ensuring that the cooling effect of the liquid cooling module 12 is uniform, avoiding excessive high local temperature differences, and thereby effectively improving the heat dissipation efficiency and temperature control performance of the liquid cooling module 12.

Furthermore, since the cooling liquid is uniformly distributed to the plurality of liquid cooling plates through the first joint pipeline assembly 125, an overall pressure drop of the liquid cooling module 12 is reduced. Therefore, there is no need to maintain the flow rate by reducing the diameter or changing the curvature of the pipelines. This embodiment allows the use of large and straight pipelines to increase the flow rate and reduce the flow resistance. In addition, in a case that the flow rate of a certain liquid cooling plate is excessively large, throttling control would be performed by adjusting diameters of inlet and outlet pipelines of the first joints 1251, thereby further optimizing the flow uniformity.

FIG. 7 is a schematic diagram of another exemplary structure of the first joint provided in an embodiment of the present disclosure.

In an embodiment, the first joint pipeline assembly 125 further includes a liquid inlet joint 12510 connected to one of the plurality of first joints 1251, and the liquid inlet joint 12510 is configured as an inlet end for a cooling medium. The second joint pipeline assembly 126 further includes a liquid outlet joint 12610 connected to one of the plurality of second joints 1261, and the liquid outlet joint 12610 is configured as an outlet end for the cooling medium.

Since the liquid inlet joint 12510 is connected to one of the plurality of first joints 1251, the flow direction of the cooling liquid is adjusted according to actual needs, thereby improving the flexibility and adaptability of the liquid cooling module 12. Moreover, by adjusting position and size of the individual liquid inlet joint 12510, the cooling liquid flows through each cooling plate via an optimal path to adapt to structural requirements of different battery packs 1 and ensure a more uniform flow distribution throughout the liquid cooling module 12.

Furthermore, the liquid inlet joints 12510 and the first joints 1251 are integrally formed. In some embodiments, the liquid inlet joints 12510 and the first joints 1251 are integrally formed by an injection molding process, thereby improving the overall sealing and connection reliability, and further improving the efficiency of the cooling liquid flow, and simplifying assembly process.

It should be noted that, in this embodiment, a structure of the liquid outlet joint 12610 in FIG. 2 can be the same as the structure of the liquid inlet joint 12510. That is, the liquid outlet joint 12610 is connected to one of the plurality of second joints 1261, and the liquid outlet joints 12610 and the second joints 1261 are integrally formed through an injection molding process. Please refer to the above description of the liquid inlet joint 12510 for details, which are not repeated in this embodiment.

As shown in FIG. 2, in an embodiment, the first joint pipeline assembly 125 further includes a first connecting joint 1253. The first connecting joint 1253 is arranged on a side of the first joint pipeline assembly 125, away from the third liquid cooling plate 121. An end of the first connecting joint 1253 is in fluid communication with the third inlet 1241 of one of the fourth liquid cooling plates 124, and another end of the first connecting joint 1253 is connected to one of the first joints 1251. The second joint pipeline assembly 126 further includes a second connecting joint 1263. The second connecting joint 1263 is arranged on the side of the second joint pipeline assembly 126 away from the third liquid cooling plate 121. An end of the second connecting joint 1263 is in fluid communication with the third outlet 1242 of one of the fourth liquid cooling plates 124, and another end of the second connecting joint 1263 is connected to one of the second joints 1261.

In some embodiments, the plurality of fourth liquid cooling plates 124 are spaced apart along the first direction Z, and the third liquid cooling plate 121 is arranged above the fourth liquid cooling plates 124. In the plurality of fourth liquid cooling plates 124, the fourth liquid cooling plate 124 away from the third liquid cooling plate 121 is in contact with a bottom plate 141141 of a box body (not shown in the drawings) of the battery pack 1, and the first connecting joint 1253 and the second connecting joint 1263 are both arranged corresponding to one of the fourth liquid cooling plates 124 away from the third liquid cooling plate 121, that is, the first connecting joint 1253 and the second connecting joint 1263 are connected to the same one of the fourth liquid cooling plates 124.

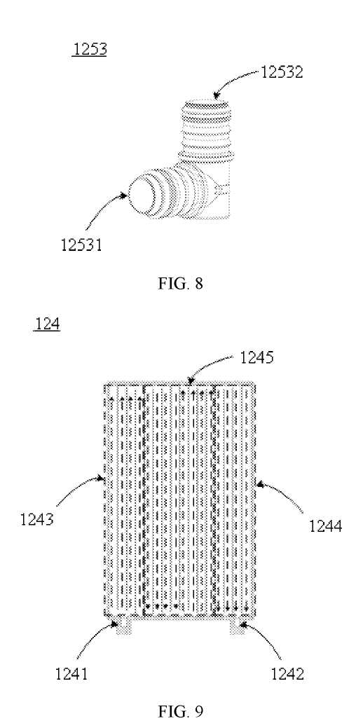

FIG. 8 is a schematic diagram of an exemplary structure of a first connecting joint provided in an embodiment of the present disclosure. As shown, the first connecting joint 1253 is a two-way joint. The first connecting joint 1253 includes a fourth opening 12531 and a fifth opening 12532 in fluid communication with each other. The fourth opening 12531 of the first connecting joint 1253 is in fluid communication with the third inlet 1241 of one of the fourth liquid cooling plates 124. The fifth opening 12532 of the first connecting joint 1253 is in fluid communication with the second opening 12512 or the third opening 12513 of the first joint 1251.

It should be noted that, in this embodiment, the structure of the second connecting joint 1263 in FIG. 2 can be the same as the structure of the first connecting joint 1253, that is, the second connecting joint 1263 is a two-way joint. Please refer to the above description of the first connecting joint 1253 for details, which are not repeated in this embodiment.

In this embodiment, as shown in FIG. 2, an end of the first connecting joint 1253 is in fluid communication with the third inlet 1241 of one of the fourth liquid cooling plates 124, another end of the first connecting joint 1253 is connected to one of the first joints 1251, an end of the second connecting joint 1263 is in fluid communication with the third outlet 1242 of one of the fourth liquid cooling plates 124, and another end of the second connecting joint 1263 is connected to one of the second joints 1261, so that a linear pipeline layout is applicable for the connection between adjacent fourth liquid cooling plates 124, reducing the bending of pipelines, and improving the flow efficiency of the cooling liquid and the flow control of the cooling liquid.

Referring to FIG. 2 in an embodiment, the first joint pipeline assembly 125 includes a third joint 1252, and the third joint 1252 is arranged between the third liquid cooling plate 121 and the first liquid cooling plate 122. The third joint 1252 is connected to the first sub-inlet 1221, the second sub-inlet 1223, the first inlet 1211, and the first joints 1251, respectively. The second joint pipeline assembly 126 includes a fourth joint 1262, and the fourth joint 1262 is arranged between the third liquid cooling plate 121 and the first liquid cooling plate 122. The fourth joint 1262 is connected to the first sub-outlet 1222, the second sub-outlet 1224, the first outlet 1212, and the second joints 1261, respectively.

In some embodiments, the third joint 1252 is a three-way joint, and the third joint 1252 is connected to the first sub-inlet 1221, the second sub-inlet 1223, the first inlet 1211, and one of the first joints 1251 through a plurality of pipelines, respectively. A pipeline connecting the third joint 1252 and the first sub-inlet 1221 is a first branch pipeline. The first branch pipeline is connected to the third joint 1252, the first sub-inlet 1221, and the first inlet 1211, respectively, so that the liquid cooling liquid flows into the third liquid cooling plate 121 and the first liquid cooling plate 122 through the one of the first joints 1251 and the third joint 1252.

The fourth joint 1262 is a three-way joint, and the fourth joint 1262 is connected to the first sub-outlet 1222, the second sub-outlet 1224, the first outlet 1212, and one of the second joints 1261 through a plurality of pipelines. A pipeline connecting the fourth joint 1262 with the first sub-outlet 1222 is configured as a second branch pipeline. The second branch pipeline is connected to the fourth joint 1262, the first sub-outlet 1222, and the first outlet 1212, respectively, so that the cooling liquid flows out of the third liquid cooling plate 121 and the first liquid cooling plate 122 through the fourth joint 1262 and the second joints 1261.

In this embodiment, the third joint 1252 and the fourth joint 1262 are arranged to reasonably distribute the cooling liquid between the third liquid cooling plate 121 and the first liquid cooling plate 122, thereby simplifying the connection of the plurality of layers of cooling plates, effectively solving the problem of how to efficiently connect the cooling plates in the multi-layered structure, eliminating the use of additional pipelines, and reducing the complexity of the liquid cooling module 12.

Furthermore, the first joint pipeline assembly 125 further includes a first pipeline 1254 arranged between the third liquid cooling plate 121 and the second liquid cooling plate 123, and the second joint pipeline assembly 126 further includes a second pipeline 1264 arranged between the third liquid cooling plate 121 and the second liquid cooling plate 123. The first pipeline 1254 is spaced apart from the second pipeline 1264.

A first through hole 1225 is formed in a side of the first liquid inlet flow channel 1227 away from the first sub-inlet 1221, and a second through hole 1226 is formed in a side of the first liquid outlet flow channel 1228 away from the first sub-outlet 1222. An end of the first pipeline 1254 is connected to the first through hole 1225, another end of the first pipeline 1254 extends from the first liquid inlet flow channel 1227 in a direction close to the second inlet 1231, and another end of the first pipeline 1254 is connected to the second inlet 1231. An end of the second pipeline 1264 is connected to the second through hole 1226, another end of the second pipeline 1264 extends from the first liquid outlet flow channel 1228 in a direction close to the second outlet 1232, and another end of the second pipeline 1264 is connected to the second outlet 1232.

Referring to FIGS. 2 and 3, in some embodiments, the first pipeline 1254 includes a first straight segment 12541, a second straight segment 12542, a third straight segment 12543, a first bending segment 12544, and a second bending segment 12545. An end of the first straight segment 12541 is in fluid communication with the first liquid inlet flow channel 1227, and another end of the first straight segment 12541 extends from the first liquid cooling plate 122 in a direction close to the third liquid cooling plate 121 and is connected to an end of the first bending segment 12544. Another end of the first bending segment 12544 is connected to an end of the second straight line segment 12542, another end of the second straight line segment 12542 extends from the third liquid cooling plate 121 in a direction close to the second liquid cooling plate 123 and is connected to an end of the second bending segment 12545. Another end of the second bending segment 12545 is connected to an end of the third straight line segment 12543, and another end of the third straight line segment 12543 extends from the second bending segment 12545 in a direction close to the second liquid cooling plate 123 and is connected to the second inlet 1231.

It should be noted that the structure of the second pipeline 1264 can be the same as the structure of the first pipeline 1254. The structure of the first pipeline 1254 has been described in detail in this embodiment, so the structure of the second pipeline is not repeated here.

It can be understood that in this embodiment, an arrangement of the first pipeline 1254 and the second pipeline 1264 simplifies the design and manufacturing process, which is conducive to standardized production and reduces manufacturing costs and maintenance difficulties. In addition, a unified pipeline structure ensures that flow characteristics of the cooling liquid in each portion are the same, further improving the stability and cooling effect of the cooling system.

Referring to FIGS. 1 and 2, in an embodiment, the second battery module 112 and the third battery module 113 are arranged in a stacked manner. The fourth battery module 114 is arranged in a same layer as and spaced apart from the third battery module 113. A groove 13 is formed between the third battery module 113 and the fourth battery module 114. The first pipeline 1254 and the second pipeline 1264 are arranged between the fourth battery module 114 and the third battery module 113. The first pipeline 1254 and the second pipeline 1264 extend along a side of the groove 13, so that they utilize the unused gap space in the battery pack 1. The arrangement of pipelines 1254 and 1264 improves the compactness of the overall layout and avoids interference between the pipelines and other elements of the battery pack 1.

In addition, through the arrangement of pipelines between adjacent battery modules 11, the cooling liquid is transferred from the second liquid cooling plate 123 to the fourth liquid cooling plates 124, thereby avoiding the intersection problem of pipelines and retaining the simplicity and maintainability of the liquid cooling module 12.

Referring to FIGS. 2-3, in an embodiment, the cooling module further includes a plurality of quick-connect plugs 127. One of the quick-connect plugs 127 corresponds to one first inlet 1211. One of the quick-connect plugs 127 corresponds to one first outlet 1212. One of the quick-connect plugs 127 corresponds to one second inlet 1231. One of the quick-connect plugs 127 corresponds to one second outlet 1232. One of the quick-connect plugs 127 corresponds to one first sub-inlet 1221. One of the quick-connect plugs 127 corresponds to one first sub-outlet 1222. One of the quick-connect plugs 127 corresponds to one second sub-inlet 1223. One of the quick-connect plugs 127 corresponds to one second sub-outlet 1224. One of the quick-connect plugs 127 corresponds to one third inlet 1241. One of the quick-connect plugs 127 corresponds to one third outlet 1242.

Referring to FIGS. 2 and 3, in some embodiments, one of the first joints 1251 is in fluid communication with the third inlet 1241 through one of the quick-connect plugs 127, and one of the second joints 1261 is in fluid communication with the third outlet 1242 through one of the quick-connect plugs 127. The third joint 1252 is in fluid communication with the first sub-inlet 1221 through one of the quick-connect plugs 127, the third joint 1252 is in fluid communication with the first sub-outlet 1222 through one of the quick-connect plugs 127, and the third joint 1252 is in fluid communication with the first inlet 1211 through one of the quick-connect plugs 127. The fourth joint 1262 is in fluid communication with the first sub-outlet 1222 through one of the quick-connect plugs 127, the fourth joint 1262 is in fluid communication with the second sub-outlet 1224 through one of the quick-connect plugs 127, and one fourth joint 1262 is in fluid communication with the first outlet 1212 through one of the quick-connect plugs 127.

In this embodiment, an arrangement of the quick-connect plugs 127 simplifies the connection method of the pipelines, avoids the complicated threaded connection or other fixing methods in related designs. Moreover, this arrangement simplifies the mounting process of the liquid cooling module 12, and reduces the space requirements for the connection and turning of the pipelines. This embodiment can make the layout of the overall system compact, especially for the cooling module designed for the multi-layered battery module 1, which can effectively save the layout space in the second direction X, making the design of the battery pack 1 flexible.

Referring to FIGS. 1, 2, and 9, FIG. 9 is a schematic diagram of an exemplary structure of a third liquid cooling plate provided in an embodiment of the present disclosure.

In one embodiment, the fourth liquid cooling plates 124 are configured as extruded liquid cooling plates. For a battery pack 1 with a multi-layered structure, a plurality of cooling plates need to be arranged. An extrusion molding process, which is characterized by high efficiency and low cost, is appliable for the extruded liquid cooling plates. Therefore, a quick and mass production of the third liquid cooling plate 121 is achieved, thereby reducing the manufacturing cost of the liquid cooling module 12.

In some embodiments, a fourth liquid inlet flow channel 1243, a fourth liquid outlet flow channel 1244, and a plurality of third liquid cooling flow channels 1245 arranged in series are arranged in each of the fourth liquid cooling plates 124. An end of the fourth liquid inlet flow channel 1243 is connected to the third inlet 1241, another end of the fourth liquid inlet flow channel 1243 is in fluid communication with an end of the third liquid cooling flow channels 1245, another end of the third liquid cooling flow channels 1245 is in fluid communication with an end of the fourth liquid outlet flow channel 1244, and another end of the fourth liquid outlet flow channel 1244 is connected to the third outlet 1242, thereby ensuring that the cooling liquid is uniformly distributed in the third liquid cooling plate 121, and improving the cooling effect of the entire liquid cooling module 12. Moreover, the fourth liquid inlet flow channel 1243, the fourth liquid outlet flow channel 1244, and the third liquid cooling flow channels 1245 are directly formed from extruded liquid cooling plates through an extrusion process, thereby further reducing the production cost of the third liquid cooling plate 121.

In some embodiments, the fourth liquid inlet flow channels 1243 of two adjacent fourth liquid cooling plates 124 are in fluid communication with each other, and the fourth liquid outlet flow channels 1244 of two adjacent fourth liquid cooling plates 124 are in fluid communication with each other, which eliminates the complex structure of the pipelines, makes the mounting process of the plurality of fourth liquid cooling plates 124 simple, and reduces the mounting cost and maintenance cost of the plurality of fourth liquid cooling plates 124.

Furthermore, the fourth liquid inlet flow channel 1243, the fourth liquid outlet flow channel 1244, and the third liquid cooling flow channels 1245 are all of linear channel structures. It can be understood that the linear flow channel structures reduce the friction and resistance of the cooling liquid in the flow channels, so as to ensure that the cooling liquid passes through each flow channel smoothly and make the cooling liquid flow quickly with less energy consumption, thereby improving the flow efficiency of the entire system. In addition, the design of the linear flow channels simplifies the manufacturing process and reduces the processing difficulty and cost caused by a complex design of the flow channels.

Embodiments of the present disclosure provide a liquid cooling module and a battery pack. The liquid cooling module includes a first liquid cooling plate and a second liquid cooling plate. A flow channel is arranged in the first liquid cooling plate. The second liquid cooling plate is spaced apart from the first liquid cooling plate. A first cooling portion is arranged at the second liquid cooling plate. The first cooling portion is in fluid communication with the flow channel to guide cooling liquid into the first cooling portion or to guide the cooling liquid out of the first cooling portion. As a result, the cooling liquid flows between the first liquid cooling plate and the second liquid cooling plate. This design simplifies a flow path of the cooling liquid, eliminates a need for bent or excessively long pipelines, and therefore increases the space utilization inside the battery pack.

What is claimed is:

1. A liquid cooling module, comprising:
a first liquid cooling plate comprising a flow channel and
a second liquid cooling plate spaced apart from the first liquid cooling plate, the second liquid cooling plate comprising a first cooling portion in fluid communication with the flow channel to guide cooling liquid into or out of the first cooling portion.

2. The liquid cooling module of claim 1, wherein the flow channel comprises a first liquid inlet flow channel and a first liquid outlet flow channel,
wherein the first liquid cooling plate comprises a second cooling portion disposed between the first liquid inlet flow channel and the first liquid outlet flow channel,
wherein the first liquid cooling plate further comprises a first sub-inlet, a first sub-outlet, a second sub-inlet, and a second sub-outlet,
wherein an end of the second cooling portion is connected to the second sub-inlet and another end of the second cooling portion is connected to the second sub-outlet,
wherein an end of the first liquid inlet flow channel is connected to the first sub-inlet, another end of the first liquid inlet flow channel is connected to an end of the first cooling portion, and
wherein an end of the first liquid outlet flow channel is connected to the first sub-outlet, and another end of the first liquid outlet flow channel is connected to another end of the first cooling portion.

3. The liquid cooling module of claim 2, wherein the second cooling portion comprises a second liquid inlet flow channel, a second liquid outlet flow channel, and a plurality of first liquid cooling flow channels arranged in parallel,
wherein an end of the second liquid inlet flow channel is connected to the second sub-inlet, another end of the second liquid inlet flow channel is in fluid communication with one end of the plurality of first liquid cooling flow channels, and another end of the plurality of first liquid cooling flow channels is in fluid communication with an end of the second liquid outlet flow channel.

4. The liquid cooling module of claim 3, wherein the first liquid inlet flow channel is not in fluid communication with the second liquid inlet flow channel, or the first liquid outlet flow channel is not in fluid communication with the second liquid outlet flow channel.

5. The liquid cooling module of claim 2, wherein the second liquid cooling plate comprises a second inlet and a second outlet, and the first cooling portion comprises a third liquid inlet flow channel, a third liquid outlet flow channel, and a plurality of second liquid cooling flow channels arranged in parallel,
wherein an end of the third liquid inlet flow channel is connected to the second inlet, another end of the third liquid inlet flow channel is in fluid communication with an end of the plurality of second liquid cooling flow channels, and another end of the plurality of second liquid cooling flow channels is in fluid communication with an end of the third liquid outlet flow channel, and another end of the third liquid outlet flow channel is connected to the second outlet.

6. The liquid cooling module of claim 5, wherein another end of the first liquid inlet flow channel is connected to the second inlet, and another end of the first liquid outlet flow channel is connected to the second outlet.

7. The liquid cooling module of claim 5, wherein the first liquid inlet flow channel, the first liquid outlet flow channel, the third liquid inlet flow channel, and the third liquid outlet flow channel comprise linear flow channel structures.

8. The liquid cooling module of claim 5, further comprising:
a third liquid cooling plate disposed below the first liquid cooling plate, wherein the second liquid cooling plate and the third liquid cooling plate are arranged in a same layer and spaced apart from each other;
a first joint pipeline assembly disposed at an end of the third liquid cooling plate; and
a second joint pipeline assembly disposed at another end of the third liquid cooling plate,
wherein the third liquid cooling plate comprises a first inlet and a first outlet, the first inlet, the first sub-inlet, and the second sub-inlet being connected to the first joint pipeline assembly, and the first outlet, the first sub-outlet, and the second sub-outlet being connected to the second joint pipeline assembly.

9. The liquid cooling module of claim 8, further comprising:
a plurality of fourth liquid cooling plates disposed on a side of the third liquid cooling plate away from the first liquid cooling plate and spaced apart along a first direction, wherein each of the plurality of fourth liquid cooling plates comprises a third inlet connected to the first joint pipeline assembly and a third outlet connected to the second joint pipeline assembly.

10. The liquid cooling module of claim 9, wherein the first joint pipeline assembly comprises a plurality of first joints in fluid communication with each other, one of the plurality of first joints is in fluid communication with the third inlet of one of the plurality of fourth liquid cooling plates, and one of the plurality of first joints positioned proximate to the third liquid cooling plate being in fluid communication with the first inlet,
wherein the second joint pipeline assembly comprises a plurality of second joints in fluid communication with each other, one of the second joints being in fluid communication with the third outlet of one of the plurality of fourth liquid cooling plates, and one of the plurality of second joints close to the third liquid cooling plate is in communication with the first outlet.

11. The liquid cooling module of claim 10, wherein the first joint pipeline assembly further comprises a liquid inlet joint connected to one of the plurality of first joints to serve as an inlet end for a cooling medium, and the second joint pipeline assembly further comprises a liquid outlet joint connected to one of the plurality of second joints to serve as an outlet end for the cooling medium.

12. The liquid cooling module of claim 11, wherein the liquid inlet joint and the plurality of first joints are integrally formed, and the liquid outlet joint and the plurality of second joints are integrally formed.

13. The liquid cooling module of claim 10, wherein each of the plurality of first joints comprises a three-way joint having a first opening, a second opening, and a third opening in fluid communication with each other, wherein the first opening of one of the first joints is in fluid communication with the third inlet of one of the fourth liquid cooling plates, and along the first direction, the second opening of one of the first joints is in fluid communication with the second or the third opening of an adjacent first joint.

14. The liquid cooling module of claim 10, wherein the first joint pipeline assembly comprises a third joint disposed between the third liquid cooling plate and the first liquid cooling plate, the third joint being connected to the first sub-inlet, the second sub-inlet, the first inlet, and the plurality of first joints, wherein the second joint pipeline assembly comprises a fourth joint disposed between the third liquid cooling plate and the first liquid cooling plate, and the fourth joint being connected to the first sub-outlet, the second sub-outlet, the first outlet, and the plurality of second joints.

15. The liquid cooling module of claim 9, wherein each of the plurality of fourth liquid cooling plates comprises a fourth liquid inlet flow channel, a fourth liquid outlet flow channel, and a plurality of third liquid cooling flow channels arranged in series, wherein an end of the fourth liquid inlet flow channel is connected to the third inlet, and another end of the fourth liquid inlet flow channel is in fluid communication with the plurality of third liquid cooling flow channels, another end of the third liquid cooling flow channels is in communication with an end of the fourth liquid outlet flow channel, and another end of the fourth liquid outlet flow channel is connected to the third outlet,
wherein fourth liquid inlet flow channels of two adjacent fourth liquid cooling plates are in fluid communication with each other, and fourth liquid outlet flow channels of two adjacent fourth liquid cooling plates are in communication with each other.

16. The liquid cooling module of claim 15, wherein the fourth liquid inlet flow channel, the fourth liquid outlet flow channel, and the plurality of third liquid cooling flow channels comprise linear channel structures.

17. The liquid cooling module of claim 8, wherein the first joint pipeline assembly further comprises a first pipeline disposed between the first liquid cooling plate and the second liquid cooling plate, an end of the first pipeline being in fluid communication with the first liquid inlet flow channel, and another end of the first pipeline extending from the first liquid cooling plate toward the third liquid cooling plate and being bent for connection to the second inlet.

18. The liquid cooling module of claim 17, wherein the first pipeline comprises a first straight segment, a second straight segment, a third straight segment, a first bending segment, and a second bending segment,
wherein an end of the first straight segment is in communication with the first liquid inlet flow channel, another end of the first straight segment extends from the first liquid cooling plate in a direction close to the third liquid cooling plate and is connected to an end of the first bending segment, another end of the first bending segment is connected to an end of the second straight line segment, another end of the second straight line segment extends from the third liquid cooling plate in a direction close to the second liquid cooling plate and is connected to an end of the second bending segment, another end of the second bending segment is connected to an end of the third straight line segment, and another end of the third straight line segment extends from the second bending segment in a direction close to the second liquid cooling plate and is connected to the second inlet.

19. A battery pack, comprising:
a battery module; and
a liquid cooling module, comprising:
a first liquid cooling plate comprising a flow channel; and
a second liquid cooling plate spaced apart from the first liquid cooling plate, the second liquid cooling plate comprising a first cooling portion, and the first cooling portion being in fluid communication with the flow channel to guide cooling liquid into or out of the first cooling portion,
wherein the battery module is arranged between adjacent liquid cooling plates.

20. The battery pack of claim 19, wherein the flow channel comprises a first liquid inlet flow channel and a first liquid outlet flow channel,
wherein the first liquid cooling plate further comprises a second cooling portion located between the first liquid inlet flow channel and the first liquid outlet flow channel,
wherein the first liquid cooling plate comprises a first sub-inlet, a first sub-outlet, a second sub-inlet, and a second sub-outlet, and
wherein an end of the second cooling portion is connected to the second sub-inlet, another end of the second cooling portion is connected to the second sub-outlet; an end of the first liquid inlet flow channel is connected to the first sub-inlet, another end of the first liquid inlet flow channel is connected to an end of the first cooling portion; an end of the first liquid outlet flow channel is connected to the first sub-outlet, and another end of the first liquid outlet flow channel is connected to another end of the first cooling portion.
